(19) United States
(12) Patent Application Publication
(10) Pub. No.: US 2005/0031101 A1
(43) Pub. Date: Feb. 10, 2005

(54) Data collection device for use with network-enabled telephone systems

(76) Inventors: Paul Renton, Sheridan, OR (US); Petel Dow, Seattle, WA (US); Daniel L. House, Kenmore, WA (US)

Correspondence Address: LAW OFFICE OF DAVID L. TINGEY, 321 BURNETT AVE. S., STE 303, RENTON, WA, 98055, US

(21) Appl. No.: 10/633,947

(22) Filed: Aug. 4, 2003

(51) Int. Cl. H04M 15/00

(52) U.S. Cl. 379/111

(57) ABSTRACT

A telephone data collection device used to collect call detail information from a telephone system with a network data port establishes a network data connection with the telephone system, collects call detail information from the telephone system and transfers the data to a host computer for processing. That host computer need not be reprogrammed to be compatible with the network-enabled telephone system, but may instead use legacy methods to poll or receive the call detail information from the device. Data may be collected from more than one network-enabled telephone system and transferred to one or more host computers through a reliable network path through a combination of serial data ports, a network, and the telephone PSTN. The data collection device stores call detail records and other information collected from a network-enabled telephone system in the data memory of the data collection device, which data is then transferred to a host using data transfer methods and protocols that are compatible with legacy systems, without requiring reprogramming of the hosts. The data collection device may collect data from a number of network-enabled telephone systems, store this data in the data memory of the data collection device and then provide the collected data to one or more hosts. It may also evaluate that data in order to detect alarm conditions reported by or existing with the network-enabled telephone system and then transmit alarm reports to a host.

### BACKGROUND OF THE INVENTION

1. Field of the Invention

This invention relates to telephone data communication systems, and more particularly to devices that interface a network-enabled private branch exchange telephone system to a computer or other host that collects telephone data from the PBX.

2. Prior Art

Traditional private branch exchange telephone systems (PBX) report call detail data about calls made and received in call records. A traditional PBX usually has a serial port that is used to provide data output of these call records to a computer or other host (hereinafter referred to as “host”). The host may processes these call records to generate call detail reports, billing reports, call management reports and other useful information.

Although the use of a serial port for the output of call detail data by a PBX is common and has worked well traditionally, it is limited in speed and requires that a device that is to receive the call detail data records be connected directly to the PBX. Many times the data contained in the call detail data records would be more valuable if stored or evaluated at a computer that is remote to the PBX, such as at a centralized billing or telecommunications management site. In such cases data collection devices, commonly called “buffer boxes,” have been used to collect the data directly from the PBX through the PBX serial port and to hold this data in a memory. The buffer box then transfers the data to a remote host through a telephone line modem or an Ethernet network connection.

Additionally, these data collection devices have traditionally been programmed to perform limited analysis of the call data records for immediate recognition of alarm conditions that are reported by the PBX. When an alarm condition is recognized then the device can issue an alarm message or initiate an outbound telephone modem call to inform the telecommunications management computer system of the alarm condition. Such alarm reporting is usually performed in addition to the data collection functions of collecting and storing the call detail records.

Many PBX units also have a data port that is used to report maintenance alarms and issues, or call distribution reports. The PBX may be used to automatically distribute calls to a queue of callers and to agents for inbound or outbound calls. Often a PBX used in this manner generates automatic call distribution reports, commonly known as ACD reports. Together with the call detail records of calls made or answered, these ACD or maintenance reports provide valuable information on the usage of the telephone system. The data collection systems used to collect call detail record information often also are used to collect these maintenance or ACD reports.

Traditional PBX units operate by connecting a number of telephone extensions to a number of conventional public switched telephone network (PSTN) central office (CO) lines. An alternative conventional method has been to connect a number of telephone extensions to the PSTN through a digital telephone line such as a TI or other digital service provided by a central office. Another method of operation of traditional PBX units is to provide communications between extensions and between the PBX and other telephone systems using network connections that employ the TCP/IP protocol suite. This method is commonly called “IP telephony” because it uses the TCP/IP protocol suite. IP telephony systems often do not have a serial port to report call detail information, although such information can be valuable. The CallManager product from Cisco Systems assembles call detail data for IP telephony systems in a database. To obtain the call detail data from this CallManager system a network connection must be established with the CallManager unit and then a database query language, such as SQL, must be used to obtain the data from the database. Conventional call record collection systems do not include the required protocols for the network connection and the database query capability so changes are required to collect this information from those conventional systems. For a conventional connection between a host that is to receive the data and the network-enabled PBX, the host must have a stored transfer protocol program that has been specifically created to operate with the network-enabled PBX, must make a network connection to the PBX and must also execute through the network connection a data collection protocol compatible with the data transfer protocol in use by the PBX.

Recently, a number of PBX manufacturers have incorporated a network data port in manufactured PBX units. A typical network-enabled PBX has a network data port and a processor connected to a program memory and a data memory that may be written to and read by the processor. Some but not all network-enabled PBXs may still include a serial interface that also may be used to send call detail records or maintenance or call distribution reports to a host. A control software program is loaded in the program memory that implements a protocol for the transfer of data through the network or serial data interface to a host computer for data processing.

The network-enabled PBX has a telephone line interface including a PTSN and network interfaces. The PTSN interface is used to connect it to one or more telephone central offices through the PSTN for acceptance of incoming calls or establishment of outbound calls. The network interface connects it to at least one host through a network to transfer data across a network. The network interface also may be used when the PBX is to answer or establish connections to hosts that operate using Voice-over-IP (VOIP) or other network-based telephonic protocols for transmission of telephone calls through a network.

The network-enabled PBX also has a telephone extension interface. The telephone extension interface may connect to telephone extensions using a telephone-line compatible interface or a network-compatible interface. The telephone-line compatible interface may interface to extensions that are compatible with the PSTN or digital extensions of a proprietary nature, in the manner well known in the art. Additionally, the network-compatible portion of the telephone extension interface may employ a network for extension telephones that are compatible with network transmission of voice and signaling information such as VoIP between the network-enabled PBX and the extension.

To perform data transmission, the network-enabled PBX processor executes a transfer protocol program stored in the program memory that directs the processor to establish a connection with a host, transfer data to or from the host under a defined protocol compatible with the host, and then possibly disconnect the connection with the host.

The data memory of the network-enabled PBX is limited in size and when full of call detail record, maintenance record or call distribution record information, the memory will either be unable to record new information as it is generated by the processor, or must have old information deleted or overwritten by new information; some data will be lost.

As noted above, some existing network-enabled PBX units may not have a local serial port, and even if they do, they likely use the network interface primarily. Such PBX units are available from Avaya, Alcatel, Mitel and perhaps other PBX manufacturers. Conventional data collection devices communicating with PBX units through a serial port are not compatible with newer network-enabled PBXs that transfer their call data records through a network data port and thus are not able to collect and report call records from network-enabled PBXs. Any data collection from these network-enabled PBX units requires new software to be created and deployed in the polling computer systems, with the attendant costs of creating and maintaining new software. Additionally, existing computing systems may not need any updating or modifications other than to add a capability to receive data from the network-enabled PBX units, but they remain unable to communicate with the network-enabled PBX units until the existing computer systems are modified. Other telecommunications management systems may be able to have data provided to them through a network connection, such as by providing an FTP server, but these systems do not include protocols employed by the network-enabled PBX units. They therefore would need to be changed to support the network protocols used by these newer, network-enabled PBX units. Also data transfer through a general network connection, such as the Internet or a local area network, is prone to having network hardware failures or even temporary unavailability of routers or firewalls, or improper configuration of these devices, preventing successful transfer of information from the data memory of the PBX, which can result in a loss of valuable information.

There are two major methods that may be employed by network hosts to establish network connections. These methods are conventionally known as a passive open and an active open. By a passive open is meant that a network host should open a network port in a manner where it is listening for a connection by another host that will make a connection to the port that was opened in a passive open manner. For example, an HTTP server used on the world wide web employs a passive open to open a port at a port number to listen for connections to be made to the server. A network host that is to connect to the HTTP server establishes a connection by communicating with the server on the port number that is in the listening state. When employing a passive open, the network host is establishing a port to which other hosts then later connect. It does not establish a connection to a particular host, but enables other hosts to establish a network connection to the host that performs the passive open. To perform a passive open the network host usually makes a function call into its operating system to specify the network address and port number on which it will be listening for connections. A passive open usually allows any host to attempt to make a connection at the specified port, but some operating systems may allow a passive open to specify that only connection attempts from a particular host or port number should be accepted. When a passive open is performed it is an internal operation of the network host to prepare the host for a potential network connection, no network traffic needs to be transmitted in order to perform the passive open.

An active open is used to establish an active, useful connection. In this case all of the network addresses and port numbers of both network hosts with which the network connection is to be established are specified. The network host performing the active open sends network traffic to the designated network host that with the connection is to be established. The target network host, if listening on the designated port and allowing the connection, then sends network traffic backs to the originating network host in order to complete the establishment of the connection. In an active open network traffic is sent out to actively establish a network connection. An example of this connection type is when a web browser is instructed by a user to connect to a particular web site using HTTP. The network address of the web site is obtained, usually by the Domain Name Service, and then an active open is performed specifying the network address of the web site host, the port number for the HTTP service, and also specifying a port number and the network address of the host operating the web browser and attempting to establish the connection. If accepted, the target network host, which had previously performed a passive open of a port to accept new connections, sends network traffic to finish establishing the connection, and then data may be transmitted back and forth between the hosts.

Some network-enabled PBX units use passive opens of their network ports, requiring a host to perform an active open on the port that the PBX is holding open awaiting a connection. Other network-enabled PBX units employ active opens when data is to be transmitted, so the host that is to establish a connection with the PBX to collect information must perform a passive open of the proper port to await connection attempts by the PBX.

FIG. 2 illustrates configuration operations for a host connection to the conventional PBX. At first step 200 the host must be configured for the particular connection type (active or passive open), for the port number on which to perform an active open or on which to listen in passive mode, for the data transmission protocol that is to be employed and for timeouts that provide a period during which the host waits after a connection has ended before establishing a new connection. The host may read these configuration items from a configuration file stored in its data memory or one or more of these configuration items may be stored as a part of the program stored in the program memory.

As further illustrated in FIG. 2, at step 202, the host branches to procedure 204 or 216 for an active or passive connection, as determined in the configuration file.

In the case of a passive open and therefore listening, the host at step 204 opens a network port on which to listen for an active connection to the port by the PBX. Then the host proceeds at step 206 to wait until the PBX establishes an active connection with the host by performing an active open on the port that the host opened at step 204. Once the network connection has been established, the host at step 208 starts performing the protocol that was selected by the configuration information to collect the information from the PBX. As information is collected the host at step 210 collects the data and places the received information into its data memory. The host then, at step 212, determines if any errors in the operation of the protocol or network connection have occurred or if the protocol session is completed. If not, the host returns to step 210 to collect more data and place it into memory and then again returns at step 212 to test for protocol or network errors or completion of the protocol session. If a protocol or network error occurred or the protocol session is completed then the host at step 214 closes the network connection and returns to step 204. At step 204 the host again performs a passive open of a network port to listen for a new connection being actively opened by the PBX.

It should also be noted that once a connection is established the host may set up a new network connection using a passive open so that multiple concurrent sessions may be employed in the manner of implementing servers with multiple threads as well known and practiced in the art.

In the case of the host performing an active open the host at step 216 first resets any timers that are used to measure time intervals that should be used to establish waiting periods between active connection attempts as based upon the configuration information established by the host in step 200. The host then proceeds at step 218 to wait any needed time period between active connection attempts to be made to the network-enabled PBX, as based upon the configuration information established by the host in step 200. After waiting in step 218, the host at step 220 performs an active open to create a network connection between the host and the PBX. At step 222 the host tests to determine if the active open was successful. If not, the host returns to step 216, whereupon the host again resets any timers and then proceeds at step 218 to wait the time required between network connection attempts.

If the active open is successful, the host proceeds to step 224 and starts performing the protocol that was selected by the configuration information and used to collect the information from the PBX. As information is collected the host at step 226 collects the data and places the received information into its data memory. The host then at step 228 determines if any errors in the operation of the protocol or network connection have occurred or if the protocol session is completed. If not, the host returns to step 226 to collect more data and place it into memory and then again returns at step 228 to test for protocol or network errors or completion of the protocol session. If a protocol or network error occurred or the protocol session is completed then the host at step 230 closes the network connection and then returns to step 216. At step 216 the host again resets any timers and proceeds at step 218 to wait any time required between network connection attempts. In this manner the host collects and stores the data from the PBX when using an active open.

With the advent of the above-described network-enabled PBX, what is needed is a data collection device that can collect data from these network-enabled PBX and IP telephony systems with their unique data transfer protocols, store the collected data and then provide methods to transfer the data to existing computing systems in a manner that these existing computing systems already employ using the data transfer protocols of these existing computer systems, different from those of the network-enabled PBX and IP telephone systems. Such a device would allow existing telecommunications management systems to then be used with network-enabled PBX units and IP telephony systems.

Additionally, due to limited buffer memory incorporated in these PBX or IP telephony units, a data collection device that collects call detail data and stores it in a memory can prevent data loss due to capacity limitations of the buffer memory of the PBX or IP telephony.

Additional issues relating to a data collection device or system for collection of call detail data records from network-enabled PBX units include the impact that having such a device may have on network security. Although the network-enabled PBX units employ data transfer over a private network connection using protocols unique to the them, system administrators are usually hesitant to provide access to telephone system equipment through a general network connection such as the Internet, as a hacker may attempt to access the phone system and obtain control of the telephone system, change its programmed settings or obtain call record data. The usual network administrative tools of using firewalls and known protocols that can be readily analyzed by network security programs or devices can break down when many new protocols must be supported or connections are allowed directly to the telephone system. Use of an intermediate data collection device could allow the usual practices of using well-known network protocols and utilizing standard firewalls while preventing unauthorized access to the telephone system.

### OBJECTS OF THE INVENTION

It is an object of the invention to provide a data collection device that can collect call detail records and other information from a network-enabled telephone system. It is a further object to have the data collection device transfer the collected call detail record or other information to a host using data transfer methods and protocols that are compatible with legacy systems. A legacy system is one that is programmed to be compatible with the data formats and transfer methods used traditionally with PBX call record or maintenance record data, which would not include the data formats and transfer methods utilized by network-enabled PBX systems. A still further object of the invention is to provide a data collection device that may collect data from a number of network-enabled telephone systems and then provide the collected data to one or more hosts. Another object of the invention is to provide a data collection device that may detect alarm conditions existing with, or reported by, a network-enabled telephone system and report these alarm conditions to a host.

### BRIEF SUMMARY OF THE INVENTION

These above objectives are achieved in a telephone data collection device that comprises a processor operationally linked to a first network interface for collection of data from a network-enabled PBX or IP telephony device, a data transfer interface for transferring call detail data or alarm messages to a host and a data memory for the collection of records and a program memory, as illustrated in FIG. 1. Throughout this description, the term “network” is intended to be broad, to include a Local Area Network (LAN), Wide Area Network (WAN), or the Internet. A software program, collection protocols, transfer protocols, a configuration file, and a data evaluation program are all stored in program memory. As also shown in FIG. 1, in addition to the first network interface primarily used for data collection from a PBX over a network, the data collection device may also comprise a collecting serial interface providing capability to receive data from a transmitting host that collects data from a PBX.

The program software directs configuration and setup by implementing the configuration file, selecting the type of collection protocol used to collect data from the network-enabled PBX or IP telephony system, IP addresses or host names for the PBX systems, port numbers to be used, modes of operation of protocols and timers for these protocols.

The processor under control of software program collects call detail data from a network-enabled PBX or IP telephony device over a network through first network connection using a collection protocol compatible with the PBX or IP telephony system. The collected call detail data is stored in a data memory. Use of data memory allows collected call detail records to remain in the memory of the device until the data is transferred to the host. In the event of network congestion or malfunction of network routers or firewalls, the data until it can be transmitted after the network operates effectively. Thus, the buffer memory of the network-enabled PBX or IP telephony unit does not overflow because the device moves the data into its data memory.

The processor provides this data through either a second network connection, a modem telephone line connection or a serial port, which together comprise the data transfer interface, to a network receiving host, a line receiving host, or a serial receiving host, respectively. The data collection device employs required protocols stored in program memory to effect the data transfer from the network-enabled PBX units to conventional receiving hosts, which protocols include the unique collection protocols to collect data from the PBX or the IP telephony system and the conventional transfer protocols that the host has been programmed to utilize.

The telephone data collection device may be configured to make network connections to more than one PBX or IP telephony system and thus collect data from more than one PBX and aggregate this data for transfer to a host. Similarly, the data collection device may make data transfer connections to multiple hosts. Thus, the data collection device may be used in several operating modes, such as to collect data from a number of PBX units and provide a single host with all of the call record data from each PBX, or to collect data from several PBX units and then provide this data to several hosts. Each host receives data collected from only one PBX or each host may receive data collected from more than one PBX. Thus, a single data collection device may be employed to collect data from multiple sites, reducing the number of required units to collect this call record data and reducing costs of deploying equipment to collect this data.

### BRIEF DESCRIPTION OF THE FIGURES

FIG. 1 shows the telephone data collection device of the invention.

FIG. 2 is a flow chart of the data collection steps taken by a conventional host to collect information from the network-enabled PBX.

FIG. 3 is a flow chart of the steps taken by the telephone data collection device of the invention to collect data from the network-enabled PBX and then transfer the collected data to a host.

FIG. 4 is a flow chart of the steps taken by the telephone data collection device of the invention to detect alarm conditions reported by, or existing with of the network-enabled PBX and then transmit alarm messages to a host.

### DETAILED DESCRIPTION OF THE PREFERRED EMBODIMENTS

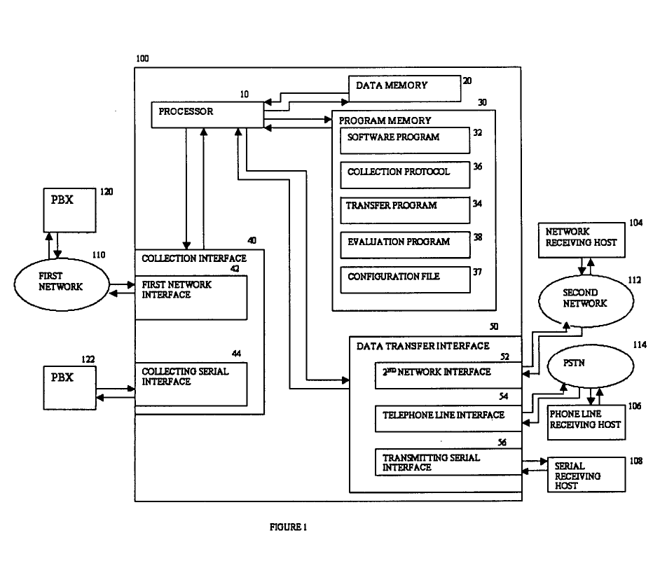

The telephone data collection device of the invention is shown in FIG. 1 comprising a computer including a processor 10 connected to a data memory 20, a program memory 30, a data collection, or input interface 40 and an data transfer, or output interface 50. As illustrated, the input interface 40 comprises a first network interface 42 and a collecting serial interface 44 and the output interface 50 comprises a second network interface 52, a telephone line interface 54, and a transmitting serial interface 56.

The processor 10 is connected to the input interface 40 and the output interface 50 to send and receive network detail call data and reads and writes that data to and from data memory 20 and program memory 30. Data that is collected by the device 10 is stored in the data memory 20 until it has been successfully transferred to one or more hosts through output interface 50. In the preferred embodiment of the invention the data memory 20 comprises one or more NAND Flash memory components, such as the TC58V64 from Toshiba.

In the preferred embodiment the processor 10 is an Intel 386EX embedded microcontroller, and the network interface 42 is a Realtek 8019AS 10BaseT controller with associated magnetic components and RJ45 connector, as well known and practiced in the art. The processor 10 is connected to the collecting serial interface 44 for receiving and sending RS232 serial data transmitted by a transmitting host 102 through a serial port. In the preferred embodiment a portion of the serial port interface is provided by UART circuitry that resides in the microcontroller, and a portion of the serial port interface 44 is provided by a Linear Technologies LT1130 serial port interface IC. A serial port connector is employed, commonly known as a DB9 or DB25 connector.

The processor is connected to the second network interface to provide connection to a network receiving host 104 through a network 112. The second network interface 52 is constructed in a manner similar to the first network interface 42, but provides a second 10BaseT controller with associated magnetic components and RJ45 network connector for a second 10BaseT Ethernet network. Note that, alternatively, the first and second network interfaces 42 and 52 may share the same network interface hardware, namely the Realtek 8019AS 10BaseT controller with associated magnetic components and RJ45 connector. In such case, a portion of network traffic transmitted and received by the processor is for communications with a first network device and another portion of network traffic transmitted and received by the processor is for communications with a second network device, as well known and practiced in the art. The two networks are shown separately in FIG. 1 to clearly indicate that data is collected by one set of operations through a first network interface and then transferred by another set of operations through a second network interface. When both network interfaces and connectors use the same network interface components and connectors or physical network the data is still collected in a first set of operations and then transferred in another set of operations, and in this case the first set of network operations can be considered to have been performed utilizing a first network interface and then the second set of operations can be considered to have been performed utilizing a second network interface.

The processor 10 is connected to telephone line interface 54 to provide a connection to the Public Switched Telephone Network (PSTN). This interface comprises a modem compatible with the PSTN and a connector commonly called an RJ11 that is used to connect to the PSTN. In the preferred embodiment the modem is a module manufactured by MultiTech and provides a 33,200 baud or 56,000 baud modem connection interface. The processor 10 is connected to a transmitting serial data interface 56 for connection to a serial receiving host 108 through an RS232 serial data line.

Software program 32 stored in the program memory 30 controls data transfer functions. The program 32 directs the processor to implement a variety of transfer protocols 34 for the collection or transfer of data, including programs to operate well-known protocols for data transfer, including Xmodem, Zmodem, FTP (network File Transfer Protocol), Telnet, SNMP Trap transmission and other well-known protocols as well as proprietary protocols. The program 32 also contains instructions to execute collection protocols 36 for the collection of data from network-enabled telephone system 120. The program 32 may also include an evaluation program 38 to analyze collected data against pre-determined alarm conditions and criteria in order to determine if some portion of data received by the processor contains evidence of an alarm condition.

As stated above, the first network interface 42 connects to a first network 110, with this first network 110 connecting to one or more PBX telephone systems 120. The second network interface 50 connects to a second network 112, with this second network 112 connecting to one or more hosts 104 that are to receive the data collected by the telephone data collection device 10, separating the first network 42 and any routing or network operational difficulties from the second network 112 and any routing or network operational difficulties attendant to that network. In this manner, the telephone data collection device 10 can continue to collect data from the PBX 120 through the first network interface 42 and network 110 while the second network interface 50, or network that is used to transfer data to the receiving host 104, is not operational.

The telephone data collection device 10 may also connect a host 102 transmitting through a transmitting serial interface 44. Use of the serial interface 44 allows the collection of data from the PBX to occur regardless of the status or health of the main network and its components. In the event of a PBX network interface failure, the telephone data collection device 10 may be able to collect information from the PBX through the serial port connection 44, store this information into its data memory 20 and then transfer this data on to receiving host. The telephone data collection device 10 is able to detect a lack of information being transferred from the PBX through the network interface 42 and change modes of data collection from a mode that collects through the network interface 110 of the PBX to the serial port 102 of the PBX in order to prevent data loss. Because the telephone data collection device can continue to collect information from the PBX as it is generated, the data memory of the PBX is prevented from becoming full, avoiding a loss of information.

The transmitting host 102 transmits received data from PBX 120′ to the data collection device 10 through serial data interface 44, which then stores the call detail data, including, maintenance and call distribution reports, data memory. This data is then transferred from data memory 20 to a receiving host 104, 106, or 108 using one of the output interfaces, for example, the second network interface 52, to transfer the data or reports to the receiving host, such as receiving host 104 through the network 112, typically employing one protocol to collect the data and a different protocol to transfer the data to a receiving host, bridging the typical inconsistencies between the transmitting PBX units and the receiving hosts. Similarly, telephone line interface 170 may be employed to transfer the data to line receiving host 106 through the PSTN 114 using appropriate protocols, such as the Xmodem or Zmodem protocols. In all data interfaces, protocols appropriate for data transmission across the respective input and output interfaces are employed. For example, for the serial data interfaces, Xmodem, Zmodem or command-based protocols are employed.

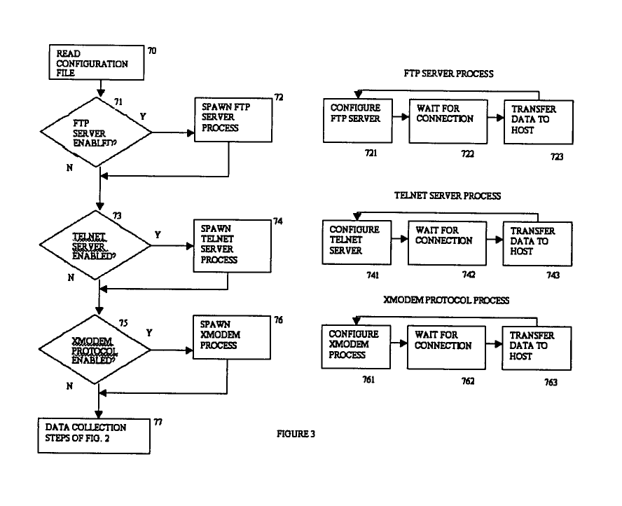

As shown in FIG. 3, data collection and transmission protocols and network connections are implemented for collecting data from the network-enabled PBX and transferring the data to a receiving host. The processor 10 under control of the software program 32 first reads a configuration file in step 70 that provides instructions regarding which protocols should be in use to transfer data to the receiving host. Typically, the configuration file is stored in the same program memory file system in which the programs are stored, though it could alternatively be stored in a portion of the data memory, which for all purposes is deemed equivalent. After reading the configuration file, the telephone data collection device 10 determines if the FTP server protocol is enabled at step 71 as a result of information in the configuration file. If so, the data collection device at step 72 loads the FTP server functions which then runs as a separate process. The FTP server process running in the data collection device at step 732 initializes a network port and waits for a connection to its FTP server at step 722. A connection is established and the collected call detail information is transferred from the data memory of the data collection device to the host at step 723, using conventional FTP server methods. Once the FTP server session is completed, the FTP server process returns to its initialization mode at step 732 to prepare a new network port for connection and waits for a new connection being made to the FTP server.

At step 73 the telephone data collection device 10 determines if a telnet command-based server protocol is enabled. If so, the data collection device at step 74 loads telnet command-based server functions. In this manner the telnet command-based server function is started up and then runs as a separate process. Whether the telnet command-based server process is spawned or not, the data collection device then proceeds, at step 75, to check for another protocol that may be in use. The telnet command-based server process running in the telephone data collection device 10 at step 741 initializes a network port and waits for a connection to its telnet server at step 742. A connection is established and, based on entry of commands across the telnet connection, the collected call detail information is transferred from the data memory of the telephone data collection device 10 to the host at step 743, using conventional telnet command-based server methods. Once the telnet command-based server session is completed, the telnet command-based server process returns to its initialization mode at step 741 to prepare a new network port for connection and waits for a new connection being made to the telnet command-based server.

Again, at step 75 the telephone data collection device 10 determines if it has been configured for another protocol that may be used. In the example shown, the telephone data collection device 10 determines if the Xmodem modem data transfer protocol is enabled. If so, the telephone data collection device 10, at step 712 provides the Xmodem modem data transfer protocol functions, or generally, that data transfer protocol corresponding to the modem discovered. In this manner the appropriate modem data transfer protocol function is started up and then runs as a separate process. The Xmodem modem data transfer process running in the telephone data collection device 10 at step 761 initializes its modem associated with the telephone line interface and waits for a connection to be made to its modem at step 762. Once a modem connection has been established, the Xmodem data transfer protocol begins at step 763 and the collected call detail information is transferred from the data memory of the telephone data collection device 10 to the host, using the conventional Xmodem data transfer protocol. Once the Xmodem session is completed, the Xmodem mode data transfer process returns to its initialization mode at step 761 to prepare the modem port to look for a new connection and waits for a new connection being made to the modem.

The telephone data collection device 10 may initialize other data transfer protocols in a similar fashion, detecting the use of each protocol and spawning a process that is used to provide the protocol functions. Such other protocols may include acting as an FTP client and making a connection to a host operating as an FTP server and transferring the data using the FTP protocol, acting as an HTTP client and making a connection to a host operating as an HTTP server and transferring the data using the HTTP protocol or methods or acting as an HTTP server and transferring the data to an HTTP client using HTTP protocols and methods.

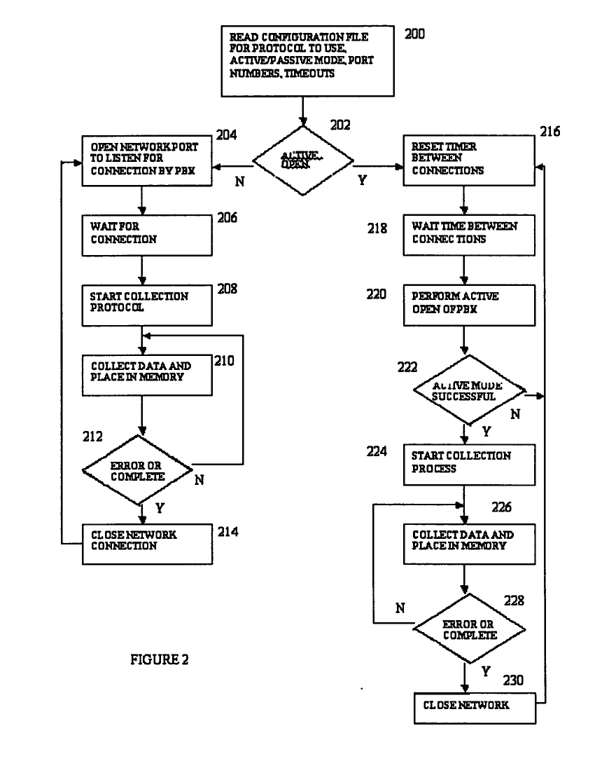

At step 77 of FIG. 3 the telephone data collection device 10 simulating a receiving host then performs the conventional data collection steps that are taken conventionally by a receiving host to collect data from the network-enabled PBX, as represented in FIG. 2, including the configuration of protocol types and the method of establishing a network connection.

The configuration information for the use of active or passive connection modes, port numbers and network addresses to use may also alternatively be read as a part of step 70 from a configuration file, and then this information used in step 200 of FIG. 6 for configuration of the protocols and network addresses and network ports. As before, in the preferred embodiment of the invention the configuration file is stored in the same program memory file system in which the programs are stored, however the configuration file could alternatively and equivalently be stored in a portion of the data memory. By following the steps as shown in FIG. 6, the call detail or maintenance or call distribution information is transferred from the network-enabled PBX to the data memory of the telephone data collection device 10.

As a result of the configuration, data collection and data transferring steps shown in FIG. 2 and FIG. 3, the telephone data collection device 10 collects data from the network-enabled PBX and stores that data into its data memory and then transfers the data to a host. Note that in this manner the protocols used by the receiving host are conventional protocols well known and practiced in the art and do not need to be changed. Thus, a large number of existing conventional hosts may be used with the telephone data collection device 10 without changes needing to be made to the hosts to utilize a new or different data collection method, such as may be used by the network-enabled PBX.

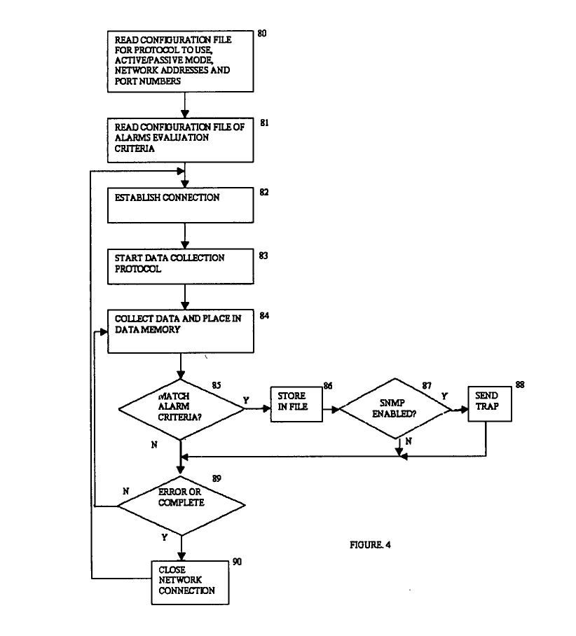

As shown in FIG. 4, the telephone data collection device 10 reads configuration data for the data collection and alarm evaluation, collects data from the network-enabled PBX, evaluates the collected data to detect alarm conditions and transmits alarm messages to a host. The Simple Network Management Protocol (SNMP) is used to transmit alarm messages to a host using the Trap message features of this protocol. Other methods of alarm notification may alternatively be used.

At step 80 the processor reads a configuration file that contains configuration data for the network address and port to use to connect to a network-enabled PBX, the method of connection (active or passive mode), the selection of a data collection protocol, and other such configuration items. Next, at step 81, the processor reads a configuration file that contains information on the criteria and methods to be used to evaluate received call record data or alarms or maintenance information records to determine if an alarm condition exists or is being reported by the network-enabled PBX. This configuration file may be stored in the data memory or program memory of the telephone data collection device 10. This configuration file may, alternatively, be contained as a part of the configuration file read by the processor in step 80. This configuration information may contain equations or instructions to monitor the data collected by telephone data collection device 10 for particular alarm messages. This configuration file may also include information that determines if an alarm reporting protocol is to be used, network addresses or port numbers or methods that are to be used in such reporting, or if the detected alarm conditions are to be stored in a file relating to detected alarms that is stored in the data memory.

Once the configuration files have been read, the telephone data collection device 10 at step 82 uses either an active or passive open to establish a connection with the network-enabled PBX, as shown in detail in FIG. 6. Once a connection has been established, the telephone data collection device 10, at step 83, starts the data collection protocol, and in step 84 begins collecting data. Once some data has been collected in step 84, the telephone data collection device 10 then, at step 85, determines if the collected data matches any of the alarm detection equations or instructions read by the processor in step 81. If so, the collected data relating to the alarm and, alternatively, a data record indicative of the alarm condition or state, at step 86, may be stored in an alarms file in the data memory, if storage of these items is enabled by the configuration file read by the processor at step 81.

The configuration data that was read by the processor at step 81 may instruct the telephone data collection device 10 to use a protocol to transmit alarm messages to a host. In the preferred embodiment of the invention the method and protocol used to report these alarms is SNMP. At step 87, the telephone data collection device 10 determines if the SNMP reporting is to be done. If so, then an SNMP Trap message is formatted and sent to the host or hosts as specified in the configuration file at step 88.

Once the storage of any alarm messages in step 86 or the transmission of any alarm messages in steps 87 and 88 is complete, or if there is no detected alarm in step 85, then the telephone data collection device 10, at step 89, determines if the protocol for the data collection is complete or if there exist any serious protocol errors. If not, then the telephone data collection device 10, at step 84, continues to receive new data from the network-enabled PBX, and evaluate the information for more alarm messages. If the protocol is complete or there is a serious protocol error then, at step 90, the telephone data collection device 10 closes the network connection, and then proceeds to step 82 in order to establish a new connection and collect and process more data from the network-enabled PBX.

Note that the file of alarm records that is stored in step 86 may be transferred to one or more hosts using the steps as shown in FIG. 7. In this manner the hosts may receive the call record data as well as data indicative of alarm conditions of one or more network-enabled PBX units.

The configuration steps shown in FIG. 6 may include configuring multiple network addresses and ports and protocols such that the telephone data collection device 10 undertakes steps to collect data from a number of network-enabled PBX units and store the data in the data memory of the telephone data collection device 10 in which case said software program directs that the input interface is selectively connectable to any one of a plurality of telephone systems and uniquely recognizes data received from each of those telephone systems, storing the data in data memory identifiable to each of said plurality of telephone systems. Similarly, the output interface may be selectively connectable to any of a plurality of host computers to which data in data memory may be transmitted.

Additionally, the telephone data collection device 10 may perform multiple simultaneous sessions utilizing multiple passive or active opens, or a combination of active and passive opens to simultaneously collect data from multiple network-enabled telephone systems and simultaneously transfer data to a number of hosts. The telephone data collection device 10 may, in this manner, also proceed as shown in FIG. 4 to collect and process alarm records simultaneously from a number of network-enabled PBX units and transmit alarm messages simultaneously to a number of hosts.

The above description of the collection of call detail records and other information from the network-enabled PBX and the subsequent transfer of this data to a host has focused generally on network connection methods. However, it will be apparent to one skilled in the art that because the telephone data collection device 10 has a telephone line interface and serial data interface available for use, the transfer of collected data may be performed using any or all of the interfaces, namely the second network interface, the telephone line interface and the serial data interface, even if not separately described. Use of these other interfaces then is deemed included in this description and the invention by simply substituting one of the other interfaces for the network interface named.

1. A telephone data collection device adapted to collect data from a telephone system having a data transmission interface through which data may be transmitted in an input protocol, said device comprising:
a computer including a processor, program memory and data memory, data communication input and output interfaces connected to said processor, the input interface comprising an network interface,
a software program loaded into program memory read and executed by the processor in implementing a network compatible data communication protocol for the network interface for data transfer to the computer through the network interface, said software program also transferring data received through the input interface between the input interface, data memory and the output interface, said software program further implementing a transmission protocol in program memory enabling transmission of data stored in said data memory through said output interface,
wherein said computer receives data from a telephone system through the network interface employing a network protocol, buffers the data in data memory, and transmits said data to a host through the output interface in a communication protocol, the output interface and communication protocol compatible with the host, converting said data received in one protocol to data transmitted in another protocol, as necessary, therein establishing data communication between the telephone system and the host.

2. The telephone data collection device of claim 1 wherein the output interface comprises a network interface.

3. The telephone data collection device of claim 1 wherein the output interface and the input interface are the same interface, receiving and transmitting data through the same network interface.

4. The telephone data collection device of claim 3 wherein data is collected the said same network interface by one set of software instructions and then transferred through said same network interface by another set of software instructions, therein separating the collection and transmission of data through said same network interface.

5. The telephone data collection device of claim 1 wherein the output interface comprises a serial interface.

6. The telephone data collection device of claim 1 wherein said input interface comprises a plurality of input interfaces and wherein the software program loads a selective communication protocol into program memory matching the input interface through which data is received.

7. The telephone data collection device of claim 6 wherein the input interface comprises a serial interface and an network interface.

8. The telephone data collection device of claim 1 further comprising a plurality of output interfaces wherein the software program loads into program memory a selective communication protocol appropriate for the output interface through which data is transmitted.

9. The telephone data collection device of claim 8 wherein the output interface comprises an network interface.

10. The telephone data collection device of claim 8 wherein the output interface comprises a serial interface.

11. The telephone data collection device of claim 8 wherein the output interface comprises a telephone line interface.

12. The telephone data collection device of claim 1 wherein the software program further comprises an evaluation program adapted to analyze received data.

13. The telephone data collection device of claim 12 wherein said evaluation program includes analysis steps to detect alarm conditions.

14. The telephone data collection device of claim 13 wherein data alarm report is transmitted through said data output interface.

15. The telephone data collection device of claim 14 wherein said data alarm report is transmitted through said data output interface along with data.

16. The telephone data collection device of claim 1 wherein said input interface is selectively connectable to any one of a plurality of telephone systems and said software program uniquely recognizes data received from each of said telephone systems, storing the data in data memory identifiable to each of said plurality of telephone systems.

17. The telephone data collection device of claim 1 wherein said output interface is selectively connectable to any of a plurality of host computers to which data in data memory may be transmitted.

18. The telephone data collection device of claim 8 wherein said plurality of input interfaces includes a telephone line interface.

19. The telephone data collection device of claim 18 wherein said telephone line interface includes a PSTN interface employing a compatible PSTN protocol.

20. The telephone data collection device of claim 18 wherein said telephone line interface includes a network interface employing a compatible network protocol.

21. The telephone data collection device of claim 1 further comprising one network interface connectable to a host and another independent network interface connectable to a PBX therein separating said one network that may experience routing or network operational difficulties from said other network and any routing or network operational difficulties that might be attendant to that network, enabling said one network to continue to collect data from a PBX via the first network interface and network while the other network interface and network that is used to transfer data to the host is not operational.

22. The telephone data collection device of claim 1 wherein the processor in communication with said data memory causes collected data to be stored in the data memory until it has been successfully transferred to at least one host through its output interface.

23. The telephone data collection device of claim 22 wherein said output interface comprises a second network interface connectable to an associated network connection, a telephone line interface, and a transmitting serial interface and wherein the collected data is transferred to at least one host through at least one of said second network interface and its associated network connection, said telephone line interface, or said transmitting serial interface.

24. The telephone data collection device of claim 1 wherein said output interface comprises a second network interface connectable to an associated network connection, a telephone line interface, and a transmitting serial interface and said software program further comprises instructions to send and receive data on said input and output interfaces, executing a variety of transfer protocols for the collection or transfer of data.

25. The telephone data collection device of claim 24 wherein said variety of transfer protocols include Xmodem, Zmodem, network File Transfer Protocol (FTP), Telnet, and Simple Network Management Protocol (SNMP) trap transmission protocols.

26. The telephone data collection device of claim 24 wherein the software program further comprises instructions to identify a protocol through which data is being transmitted by a PBX and initiating a matching data transfer protocol at said input interface for receiving said data.

27. The telephone data collection device of claim 24 wherein said protocols may include a protocol simulating an FTP client, enabling connection to a host operating as an FTP server and transfer of data using a FTP protocol, acting as an HTTP client and making a connection to a host operating as an HTTP server and transferring the data using an HTTP protocol or methods or acting as an HTTP server and transferring the data to an HTTP client using HTTP protocols and methods.

28. The telephone data collection device of claim 24 wherein said protocols may include a protocol simulating an HTTP client enabling a connection to a host operating as an HTTP server and transfer of the data using an HTTP protocol

29. The telephone data collection device of claim 26 wherein said variety of transfer protocols includes a protocol for the collection of data from a network-enabled telephone system.

30. The telephone data collection device of claim 24 wherein said variety of transfer protocols includes an evaluation program that analyzes collected data against pre-determined alarm conditions and criteria to determine if some portion of received data contains evidence of an alarm condition.

31. The telephone data collection device of claim 1 wherein said input network interface is connectable through the network to a plurality of PBX telephone systems.

32. The telephone data collection device of claim 1 wherein said output network interface is connectable through the network to a plurality of hosts that are to receive the data collected by the telephone data collection device.

33. The telephone data collection device of claim 2 wherein the input interface further comprises an input serial interface connectable to a PBX host transmitting data through a PBX serial interface, said data receivable through said input serial interface and transferable through the output network interface therein transferring the data transmitted from a PBX through a serial protocol for data communication to a receiving host through the output interface employing a protocol for data communication matching the output network interface.

34. The telephone data collection device of claim 33 wherein the output interface comprises an network interface employing an network protocol.

35. The telephone data collection device of claim 33 wherein the output interface comprises a telephone line interface employing the PSTN, the collected data transferring to said receiving host through the telephone line interface and the PSTN using appropriate protocols

36. The telephone data collection device of claim 35 wherein said protocols comprise Xmodem or Zmodem protocols.

37. The telephone data collection device of claim 1 wherein the software program includes instructions to emulate a receiving host compatible with a network-enabled telephone systems for receiving data therefrom, including configuration of protocol types and establishing a network connection.

38. The telephone data collection device of claim 37 wherein configuration information for use in establishing a network connection with a network-enabled PBX either in active or passive connection modes, port numbers and network addresses is contained in a configuration file stored in computer memory.

39. The telephone data collection device of claim 37 configured with multiple network addresses and ports and protocols providing data communication with a plurality of network-enabled telephone systems, the data received stored in the data memory.

40. The telephone data collection device of claim 39 configured with multiple passive or active data communication connections to a plurality of network-enabled telephone systems and hosts, respectively, enabling multiple simultaneously data collection from said multiple network-enabled telephone systems and simultaneous transfer of data to said plurality of hosts.

41. The telephone data collection device of claim 40 configured to collect and process alarm records simultaneously from a plurality of network-enabled PBX units and transmit alarm messages simultaneously to a plurality of hosts.

42. The telephone data collection device of claim 37 wherein the software program includes instructions that configure the output interface for data transfer to a receiving host, implementing appropriate data transfer protocols as provided in a configuration file and loading FTP server functions as an initialization mode if a FTP server protocol is enabled to run as a separate process in initializing a network port and waiting for a connection to its FTP server upon which data is transferred from the data memory to the receiving host, returning to its initialization mode to prepare a new network port for connection and waiting for a new connection to be made to the FTP server when the data transfer is completed.

43. The telephone data collection device of claim 37 wherein the software program includes instructions that configure the output interface for data transfer to a receiving host, implementing appropriate data transfer protocols as provided in a configuration file and loading telnet command-based server functions as an initialization mode if a telnet server protocol is enabled to run as a separate process in initializing a network port and waiting for a connection to its telnet server upon which data is transferred from the data memory to the receiving host, returning to its initialization mode to prepare a new network port for connection and waiting for a new connection to be made to the telnet server when the data transfer is completed.

44. The telephone data collection device of claim 37 wherein the software program includes instructions that configure the output interface for data transfer to a receiving host, implementing appropriate data transfer protocols as provided in a configuration file and loading server functions appropriate for that protocol as an initialization mode if data transfer protocol is enabled to run as a separate process in initializing a network port and waiting for a connection to its matching server upon which data is transferred from the data memory to the receiving host, returning to its initialization mode to prepare a new network port for connection and waiting for a new connection to be made to the matching server when the data transfer is completed.
